(19) United States
(12) Patent Application Publication
(10) Pub. No.: US 2016/0092082 A1
(43) Pub. Date: Mar. 31, 2016

(54) Visualizing Relationships Between Entities in Content Items

(71) Applicant: Apple Inc., Cupertino, CA (US)

(72) Inventors: Behkish J. Manzari, San Francisco, CA (US); Graham R. Clarke, Mountain View, CA (US); Henrique D. Penha, San Francisco, CA (US); Pani Page, San Francisco, CA (US); Paulo M. Lopez, Los Gatos, CA (US)

(21) Appl. No.: 14/501,015

(22) Filed: Sep. 29, 2014

(51) Int. Cl. G06F 3/0484

(52) U.S. Cl. CPC G06F 3/04845; G06F 3/04842; G06F 3/04847

(57) ABSTRACT

Some embodiments provide a method for displaying relationships in content. From several entities that appear in a set of content items and for which representations are displayed in a graphical user interface (GUI), the method receives a selection of one or more of the entities through the representations in the GUI. For each non-selected entity of a set of non-selected entities of the several entities, the method determines a count of content items in the set of content items in which the one or more selected entities and the non-selected entity appear. The method displays in the GUI a visualization of the representations of the several entities that indicates which of the entities are selected and the counts for each of the set of non-selected entities.

### BACKGROUND

Tagging of people in images is commonplace nowadays. Both on social media sites as well as personal image organization applications, users can tag themselves, their friends and family, etc. in photographs. In such applications, the user can then identify all of the photographs in which they appear, or in which a particular family member appears. However, this only provides a limited amount of information about a single tagged person at a time.

### BRIEF SUMMARY

Some embodiments provide a method for displaying a graphical representation of relationships between entities that appear in a set of content items. Specifically, within a defined set of content items (e.g., a content library) some embodiments determine the number of co-appearances of selected entities in content items. In addition, for each particular non-selected entity of a set of non-selected entities, some embodiments determine the number of co-appearances of the selected entities along with the particular non-selected entity (i.e., the number of content items in which all of the selected entities and the particular non-selected entity appear). The method of some embodiments generates a visualization of these relationships that indicates, e.g., which of the entities are selected and the numbers of co-appearances of the different combinations of entities.

In some embodiments, the graphical representation is displayed for an image library by an image organization application. Images catalogued by the image organization application of some embodiments may include tags that indicate the presence of various entities in the images (e.g., people's faces, pets or other animals, non-living entities such as inanimate objects or locations, etc.). The image organization application of some embodiments includes a graphical user interface (GUI) that allows a user to view the various entities tagged in the images of the image library, and select one of the entities in order be presented with the images in which the entity is tagged.

Some embodiments display the various entities in a hierarchical fashion, with the entities presented as different sizes based on their relative importance to the user of the image organization application. For instance, some embodiments present representations of several of the entities most important to the user as a largest size across the top of the GUI, several more representations of the entities as an intermediate size in the middle of the GUI, and additional representations of less important entities as a smallest size at the bottom of the GUI, although other arrangements are possible. The importance of the entities may be determined based on user input (e.g., a user may move the displayed representations of the entities between the different groups in the hierarchy) or automatically by the application (e.g., based on the number of images tagged with the different entities).

Within this GUI, the user may select one or more of the tagged entities in order to view information about the images that contain the selected entities. Specifically, when the user selects one of the entities, some embodiments identify, for each pairing of the selected entity with one of the other non-selected entities, the number of images that contain both the selected entity and the non-selected entity. For example, if a user selects the first of three entities, some embodiments determine (i) the number of images containing both the first entity and the second entity and (ii) the number of images containing both the first entity and the third entity. When the user selects two or more entities, some embodiments identify both (i) the number of images that contain all of the selected entities and, (ii) for each grouping of the selected entities and one non-selected entity, the number of images that contain all of the selected entities and the non-selected entity. For example, if a user selects the first and second entities in a group of four entities, such embodiments determine (i) the number of images containing both the first and second entities, (ii) the number of images containing the first, second, and third entities, and (iii) the number of images containing the first, second, and fourth entities.

After determining the counts of the different groups of entities in the set of content items, some embodiments display a visualization of the relationships between the entities in the content items. In the case of the image organization application, some embodiments graphically display connections between the representations of the entities, with the connections indicating the determined numbers of images for each visualized relationship. For instance, when a user selects a representation of a particular entity, some embodiments draw lines connecting the particular entity representation to several other entity representations, with a selectable item for each line that indicates the number of images in which both the particular entity and the other entity both appear. When the user selects a second representation of a second entity, some embodiments display a line connecting the representations of the two selected entities along with a selectable item that indicates the number of images in which both of the selected entities appear. Furthermore, some embodiments display additional lines off of the primary line that connect to the representations of one or more other entity representations, along with selectable items indicating the number of images in which both the selected entities and the other entity appear together. In some embodiments, the representations of the entities remain static as the application draws the connecting lines. In other embodiments, however, the application moves the representations within the GUI, such that the representations of the selected entities are displayed next to each other (e.g., at the top), while the representations of the other entities that appear in images along with the selected entities are displayed underneath (e.g., in a fanning graph display). The other representations that do not appear in any images are displayed away from the connected entity representation (e.g., along the bottom).

In some embodiments, the items within the visualization that indicate the number of co-appearances in the set of content items are selectable in order to bring up a display of the corresponding content items. In the case of the image organization application, selection of one of the items indicating the number of images in which a set of entities appear causes the application to display thumbnails of the images in which those entities appear. This enables the user to use additional features of the image organization application to generate a card, photobook, slideshow, etc. using the images, in some embodiments.

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a software architecture diagram of some embodiments of the invention for graphically displaying a representation of relationships between entities in a set of content items.

FIG. 2 illustrates an example of a GUI of some embodiments of the image organization application.

FIG. 3 conceptually illustrates a process of some embodiments for generating a displaying a visualization of the relationships between entities that appear within content items.

FIG. 4 illustrates an image organization application GUI in which the user selects a representation of an entity and the application displays a visualization of the relationships of the selected entity to the other entities within the user's library of images.

FIG. 5 illustrates the same GUI of FIG. 4 as the user selects a second entity representation.

FIG. 6 illustrates the selection of a third entity in the GUI of FIG. 4 and the resulting visualization.

FIG. 7 illustrates the selection of a GUI item and the resulting display of images in the GUI of FIG. 4.

FIG. 8 illustrates an image organization application GUI in which the user selects representations of several entities and the application displays a visualization of the relationships of the selected entity or entities to each other and to non-selected entities.

FIG. 9 illustrates the GUI of FIG. 8 in which the user selects a third entity for the relationship visualization.

FIG. 10 illustrates the selection of a GUI item and the resulting display of images in the GUI of FIG. 8.

FIG. 11 illustrates an image organization application GUI in which the user selects a representation of an entity in order to cause the application to display a visualization of the relationships of the selected entity to other entities that appear in the user's library of images.

FIG. 12 illustrates the selection of additional entities in the GUI of FIG. 11.

FIG. 13 conceptually illustrates a state diagram 1300 that shows states and changes between the states for the image organization application GUI of some embodiments.

FIG. 14 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for displaying a graphical representation of relationships between entities that appear in a set of content items. Specifically, within a defined set of content items (e.g., a content library) some embodiments determine the number of co-appearances of selected entities in content items. In addition, for each particular non-selected entity of a set of non-selected entities, some embodiments determine the number of co-appearances of the selected entities along with the particular non-selected entity (i.e., the number of content items in which all of the selected entities and the particular non-selected entity appear). The method of some embodiments generates a visualization of these relationships that indicates, e.g., which of the entities are selected and the numbers of co-appearances of the different combinations of entities.

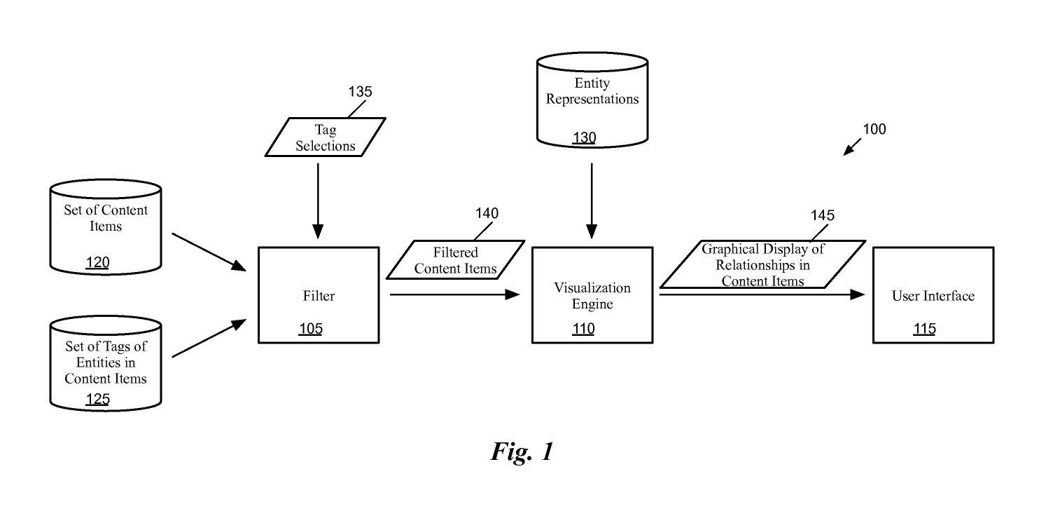

FIG. 1 conceptually illustrates a software architecture diagram 100 of some embodiments of the invention for graphically displaying a representation of relationships between entities in a set of content items. The software architecture 100 could represent modules within an operating system or an application that runs on top of an operating system in different embodiments. As shown, the entity relationship software 100 includes a filter 105, a visualization engine 110, and a user interface 115. In addition, the software uses three sets of stored data: a set of content items 120, a set of tags of entities in the content items 125, and a set of entity representations 130.

The set of content items 120, in some embodiments, is a set of items of one or more types. For instance, the content items might be text documents, audio files, images (e.g., photographs), videos, etc. The entities for which tags 125 are stored may be any type of entity that can be appear in a content item. Thus, the entities could be words in text, specific people, pets, objects, locations, etc. in images or video, sound snippets in audio, words or ideas in audio, images in video, etc. In different embodiments, the tags may be user-generated or automatically detected by the application that implements the graphical representations (or by a different application).

For example, in some embodiments the graphical representations of relationships are displayed for an image library by an image organization application. Images catalogued by the image organization application of some embodiments may include tags that indicate the presence of various entities in the images (e.g., people's faces, pets or other animals, non-living entities such as inanimate objects or locations, etc.). The image organization application of some embodiments includes a graphical user interface (GUI) that allows a user to view the various entities tagged in the images of the image library, and select one of the entities in order be presented with the images in which the entity is tagged.

The entity representations 130 of some embodiments are graphical representations of the entities used to represent the entities in the GUI. For instance, when the entities are items (e.g., faces of people or pets, locations, tangible items, etc.) tagged within images, some embodiments select (e.g., automatically or via a user selection) one of the tagged image regions for each entity to represent the entity in the GUI. Some embodiments display the various entities in a hierarchical fashion, with the entities presented as different sizes based on their relative importance to the user of the image organization application. For instance, some embodiments present representations of several of the entities most important to the user as a largest size across the top of the GUI, several more representations of the entities as an intermediate size in the middle of the GUI, and additional representations of less important entities as a smallest size at the bottom of the GUI, although other arrangements are possible. The importance of the entities may be determined based on user input (e.g., a user may move the displayed representations of the entities between the different groups in the hierarchy) or automatically by the application (e.g., based on the number of images tagged with the different entities).

The filter 105 of some embodiments uses tag selections 135 from a user to identify a set of filter content items 140. In some embodiments, the filtered content items 140 are a set of content items 120 whose tags 125 match the tag selections 135 according to a particular heuristic. For example, some embodiments identify all of the content items 120 that have all of the selected tags 135. In addition, some embodiments identify, for each particular unselected entity, the content items that are tagged with all of the selected entities and the particular unselected entity.

Within the image organization application GUI, the user may select the representation of one or more of the tagged entities in order to view information about the images that contain the selected entities. Specifically, when the user selects one of the entities, some embodiments identify, for each pairing of the selected entity with one of the other non-selected entities, the number of images that contain both the selected entity and the non-selected entity. For example, if a user selects the first of three entities, some embodiments determine (i) the number of images containing both the first entity and the second entity and (ii) the number of images containing both the first entity and the third entity. When the user selects two or more entities, some embodiments identify both (i) the number of images that contain all of the selected entities and, (ii) for each grouping of the selected entities and one non-selected entity, the number of images that contain all of the selected entities and the non-selected entity. For example, if a user selects the first and second entities in a group of four entities, such embodiments determine (i) the number of images containing both the first and second entities, (ii) the number of images containing the first, second, and third entities, and (iii) the number of images containing the first, second, and fourth entities.

The filtered content item data 140, along with the entity representations 130, is used by the visualization engine 110 to generate a graphical display 145 of relationships within the content items. This graphical display 145 is presented within the user interface 115. Different embodiments may provide different graphical displays. For instance, some embodiments highlight the representations of the selected entities and display connections between the selected entities as well as the non-selected entities that also appear in the content items with the selected entities. Within the visualization, some embodiments indicate the number of content items with the different sets of tags, or show the content items themselves (or representations of the content items).

In the case of the image organization application, some embodiments graphically display connections between the representations of the entities, with the connections indicating the determined numbers of images for each visualized relationship. For instance, when a user selects a representation of a particular entity, some embodiments draw lines connecting the particular entity representation to several other entity representations, with a selectable item for each line that indicates the number of images in which both the particular entity and the other entity both appear. When the user selects a second representation of a second entity, some embodiments display a line connecting the representations of the two selected entities along with a selectable item that indicates the number of images in which both of the selected entities appear. Furthermore, some embodiments display additional lines off of the primary line that connect to the representations of one or more other entity representations, along with selectable items indicating the number of images in which both the selected entities and the other entity appear together. In some embodiments, the representations of the entities remain static as the application draws the connecting lines. In other embodiments, however, the application moves the representations within the GUI, such that the representations of the selected entities are displayed next to each other (e.g., at the top), while the representations of the other entities that appear in images along with the selected entities are displayed underneath (e.g., in a fanning graph display). The other representations that do not appear in any images are displayed away from the connected entity representation (e.g., along the bottom).

In some embodiments, the items within the visualization that indicate the number of co-appearances in the set of content items are selectable in order to bring up a display of the corresponding content items. In the case of the image organization application, selection of one of the items indicating the number of images in which a set of entities appear causes the application to display thumbnails of the images in which those entities appear. This enables the user to use additional features of the image organization application to generate a card, photobook, slideshow, etc. using the images, in some embodiments.

Many more details of embodiments of the visualization of relationships between entities in a set of content items will be described in the sections below. Section I introduces the image organization application GUI of some embodiments. Section II then describes in detail the generation and display of visualizations of relationships between entities within a set of content items, providing examples from the image organization application of some embodiments. Finally, Section III describes an electronic system with which some embodiments of the invention are implemented.

### I. Image Organization Application GUI

In the following sections, the visualization of relationships between entities will be described in the content of an image organization application. However, one of ordinary skill in the art will recognize that the invention is not limited to displaying visualizations of relationships between tagged items within images. For instance, the content items could include video, audio, text, etc. The content items could also include a user's communications (e.g., text messages, e-mails, audio and/or video calls, etc.), and the contacts of the user (i.e., the people with which the user has those communications) could be the entities. The visualization of some embodiments then indicates the number and/or type of communications between different groups of contacts.

The image organization application of some embodiments may provide image organization functions (e.g., the ability to tag images, group images into collections, etc.), image-editing capabilities, content creation functions (e.g., the ability to create new content using the images, such as cards, photobooks, photo journals, etc.), and other such functions. Thus, the image organization application is not limited to being merely a simple image viewer, but may provide other image-usage functions as well.

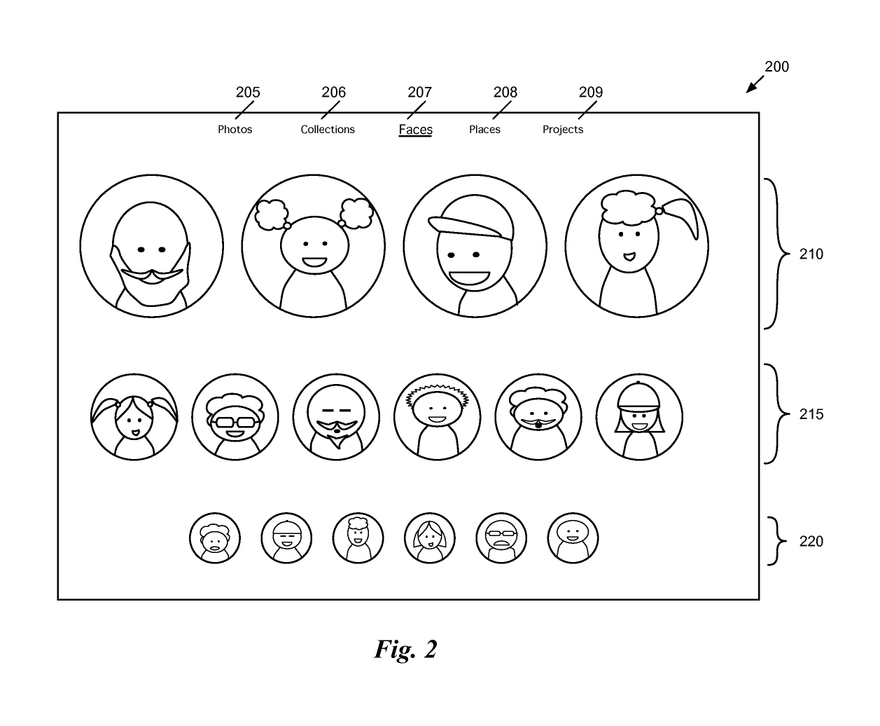

FIG. 2 illustrates an example of a GUI 200 of some embodiments of the image organization application. As shown in the figure, the GUI 200 includes five selectable tabs 205-209 that relate to different ways of organizing a user's images. Selection of the photos tab 205, in some embodiments, causes the application to display all of the images within the photo library of the image organization application. When selected, the collections tab 206 of some embodiments causes the application to display different collections into which the user has organized the images in the photo library. The places tab 208 relates to the organization of images based on the locations at which those images were captured, and the projects tab 209 enables the user to view various projects they are creating with the images (e.g., photobooks, cards, slideshows, etc.).

The faces tab 207 is currently selected in the GUI 200. As shown, the GUI 200 for the faces tab displays representations of entities (often faces of people) tagged in images stored by the image organization application. In some embodiments, the image organization application includes face detection capabilities. The application identifies the locations of faces within an image, and provides an interface for the user of the application to input names for the different faces. When a user inputs the same name for faces in different images, these images will be grouped together based on this tagged entity. In addition to face detection, users may tag other items (i.e., items other than detected faces) in the images. This allows users to tag any people that might not be detected as such (e.g., because the face is mostly covered up or not shown), as well as other entities such as pets, objects (e.g., food, jewelry items, etc.), locations (e.g., a house, a room, a backyard, a park, a building, etc.).

In the GUI 200, the different faces are shown within circles. For entities that are tagged in multiple images, some embodiments select a particular instance of the entity and generate a representation of the entity. Some embodiments select the first tagged instance, allow the user to choose an instance for the representation, make a judgment on which is the clearest instance of the entity using a set of heuristics, etc. To generate the representation, some embodiments identify a portion of the image that is tagged and attempt to center the entity within the representation. Though not shown in FIG. 2, some embodiments display names for the entities along with the representations in the GUI 200.

Some embodiments display the entity representations in a hierarchical manner, as shown in FIG. 2. Specifically, the entities are displayed as different sizes based on their relative importance to the user of the application. While in this case the representations of the entities are split into three groups 210-220, different embodiments may use different numbers of groups with intermediate sizes. Some embodiments present the representations of several of the entities most important to the user as a largest size across the top of the GUI, several more representations of the entities as an intermediate size in the middle of the GUI, and additional representations of less important entities as a smallest size at the bottom of the GUI, although other arrangements are possible. The importance of the entities may be determined based on user input (e.g., a user may move the displayed representations of the entities between the different groups in the hierarchy) or automatically by the application (e.g., based on the number of images tagged with the different entities). Some embodiments keep the number of entities in at least some of groups fixed (e.g., at 4 entities in the largest group), while other embodiments allow for different numbers of representations in the different groups. For example, users with different size families might want to have different numbers of entities in the top group.

In some embodiments, the representations are selectable (using a first type of selection) to cause the application to display the set of images in which the entity appears. In addition, as described in the following sections, the representations of some embodiments are selectable (using a second type of selection) in order to cause the application to display a visualization of the relationships between the selected entity and the other entities within the collection of images.

### II. Generation and Display of Visualization of Relationships

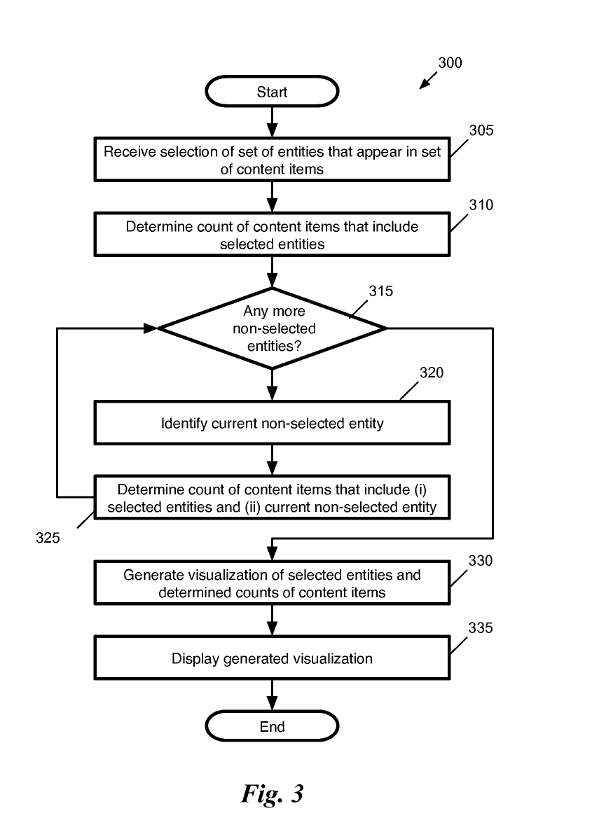

FIG. 3 conceptually illustrates a process 300 of some embodiments for generating a displaying a visualization of the relationships between entities that appear within content items. The process 300 may be performed by an image organization application as described by reference to the subsequent figures, but may also be performed by an operating system or a different application for any set of content items and entities tagged within those content items (e.g., audio, video, text, communications with others, etc.).

As shown, the process 300 begins by receiving (at 305) a selection of a set of entities that appear in a set of content items. The selection might be from a user selection (e.g., a selection with a cursor controller, a touch selection from a touch input device, etc.) in some embodiments. The user may select one entity or multiple entities in some embodiments. In the image organization application example, the user might select one or more entities (e.g., people, pets, objects, etc.) that are tagged within images organized by the application.

The process then determines (at 310) a count of the content items that include the selected entities. In some embodiments, this is a count of the items that include all of the selected entities. For instance, if two entities tagged in images are selected, the image organization application of some embodiments identifies the intersection of the set of images in which the first entity is tagged and the set of images in which the second entity is tagged. Thus, content items that include only one of the entities and not the other entity are excluded from this count.

In some embodiments, only the count of content items with all of the selected entities is determined when more than one entity is selected. In this case, the application or module performing the relationship visualization process does not perform operations 315-325 or similar operations. However, some embodiments also generate counts of content items that include all of the selected entities as well as different non-selected entities, in order to provide further information about the relationships of the appearance of the various entities in the set of content items.

Thus, the process next determines (at 315) whether any more non-selected entities remain for analysis. If there are no non-selected entities, then operations 320 and 325 are not performed. Furthermore, once all non-selected entities in the set of entities have been processed by these operations (to determine the relationships of the non-selected entities to the selected entities), the process advances to operation 330.

Otherwise, so long as at least one non-selected entity remains for processing, the process identifies (at 320) a current non-selected entity. Some embodiments perform the entity relationship process for all non-selected entities, while other embodiments perform this processing for only some of the non-selected entities. For example, in the case of the image organization application shown in FIG. 2, some embodiments only identify and display the relationships of the selected entity to other entities within the same level of hierarchy as the selected entities (or levels if entities from multiple groups are selected). Different embodiments may use different criteria to determine which non-selected entities are processed.

The process 300 then determines (at 325) a count of the content items that include (i) the selected entities and (ii) the current non-selected entity. For any non-selected entity, this count will always be less than or equal to the count of content items that include all of the selected entities, determined at 310. However, for all of the non-selected entities, the total counts may combine to be much greater than the count determined at 310. This is because content items that include two non-selected entities as well as all of the selected entities will be included in the counts for both of the non-selected entities. That is, the process of some embodiments identifies the set of content items that are tagged with at least the selected entities and the current non-selected entity, but may also have additional entities tagged. In some embodiments, the user can add one or more of the non-selected entities to the set of selected entities in order to be presented with more details regarding the relationships of the specific entities in the content items.

After all of the non-selected entities have been processed, the process 300 generates (at 330) a visualization of the selected entities and the counts of the content items determined at 310 and 325 indicating the relationships between the entities within the content items. The process then displays (at 335) the visualization (e.g., in the user interface of the application performing the process 300). In some embodiments, the application highlights the selected entities and displays connections between the selected entities and the non-selected entities (i.e., connections from one selected entity to another as well as connections from the selected entities to the separate non-selected entities).

In the case of the image organization application, some embodiments graphically display connections between the representations of the entities, with the connections indicating the determined numbers of images for each visualized relationship. For instance, when a user selects a representation of a particular entity, some embodiments draw lines connecting the particular entity representation to several other entity representations, with a selectable item for each line that indicates the number of images in which both the particular entity and the other entity both appear. When the user selects a second representation of a second entity, some embodiments display a line connecting the representations of the two selected entities along with a selectable item that indicates the number of images in which both of the selected entities appear. Furthermore, some embodiments display additional lines off of the primary line that connect to the representations of one or more other entity representations, along with selectable items indicating the number of images in which both the selected entities and the other entity appear together.

In some embodiments, the representations of the entities remain static as the application draws the connecting lines. In other embodiments, however, the application moves the representations within the GUI, such that the representations of the selected entities are displayed next to each other (e.g., at the top), while the representations of the other entities that appear in images along with the selected entities are displayed underneath (e.g., in a fanning graph display). The other representations that do not appear in any images are displayed away from the connected entity representation (e.g., along the bottom).

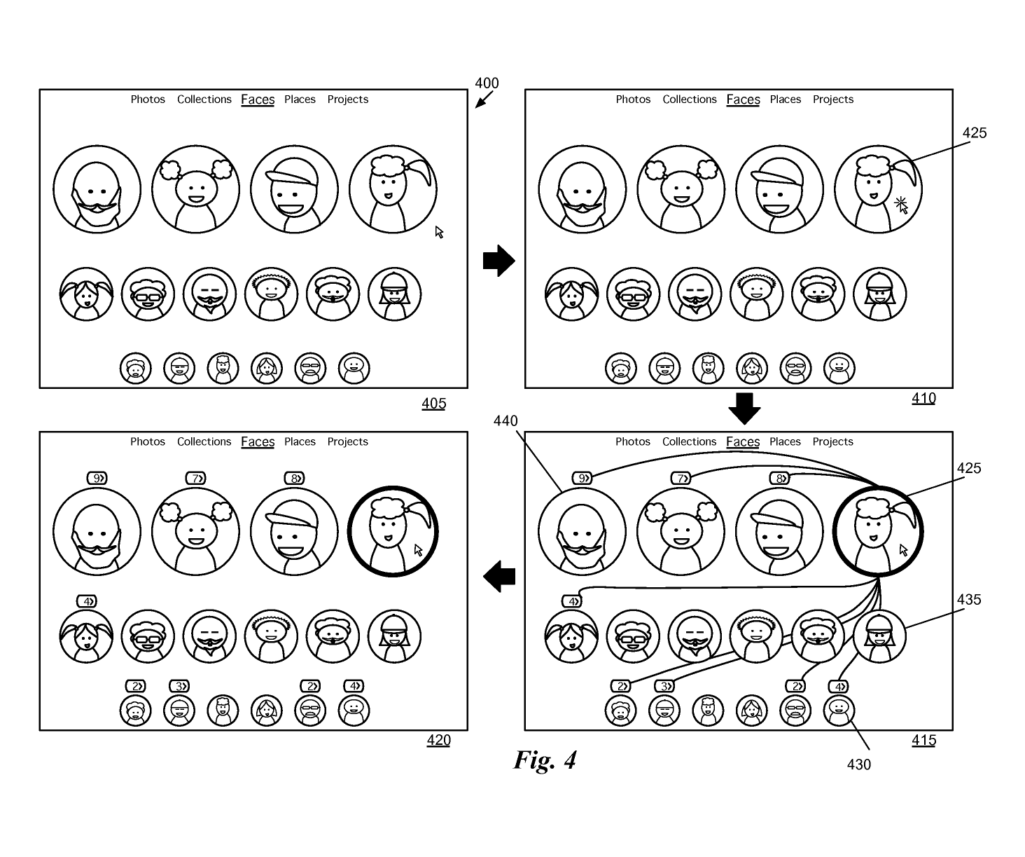

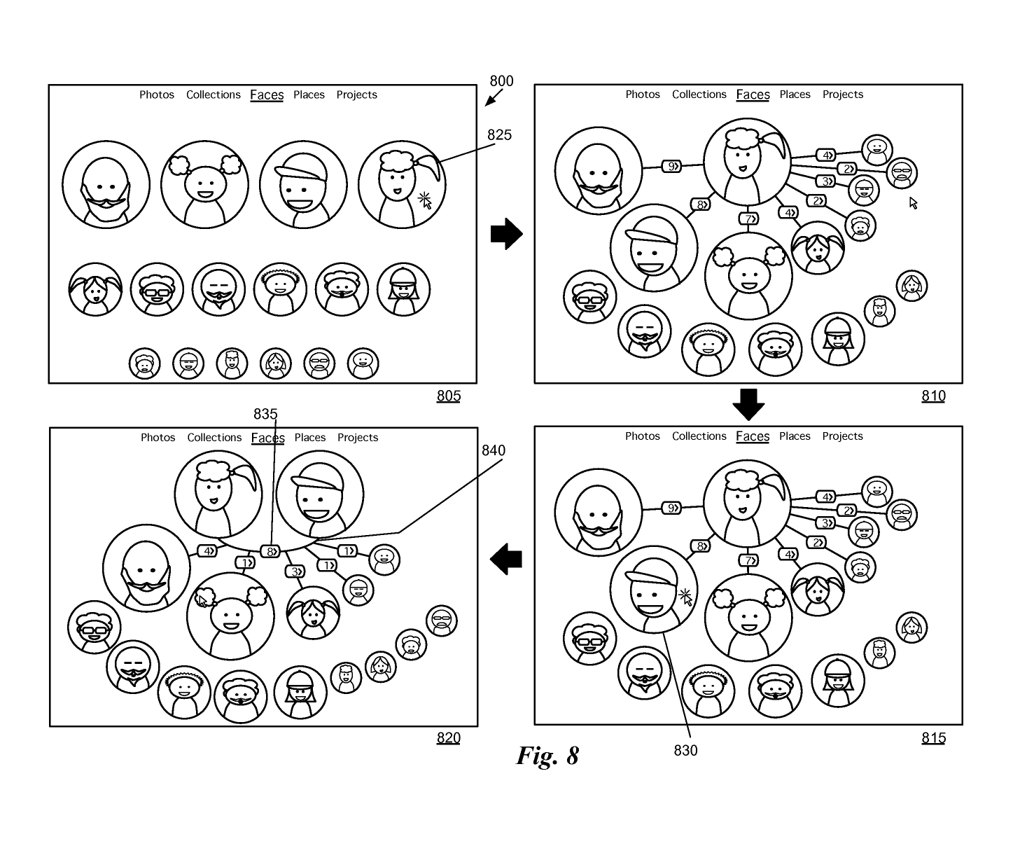

FIGS. 4-12 illustrate different examples of the visualization of these relationships within the image organization application GUI of some embodiments. As indicated in the above paragraphs, different embodiments may use different visualizations. FIGS. 4-7 and 11-12 illustrate embodiments in which the entity representations are static, while FIGS. 8-10 illustrate embodiments in which the entity representations move within the GUI upon selection of one or more of the representations.

FIG. 4 illustrates four stages 405-410 of an image organization application GUI 400 in which the user selects a representation of an entity and the application displays a visualization of the relationships of the selected entity to the other entities within the user's library of images. As shown, the first stage 405 illustrates the GUI 400 before any selections have been made. This stage 405 is similar to the GUI 200 described above, with various entity representations displayed in three levels of hierarchy.

In the second stage, the user selects an entity representation 425. In this example, a user positions a cursor controller over the entity representation 425 and provides a selection input (e.g., a single-click or double-click of a mouse, a single or double tap of a touchpad, a keystroke input, etc.). While the examples shown in this figures as well as the subsequent figures illustrate cursor controller input, one of ordinary skill in the art will recognize that the various types of input shown could be received through a touchscreen or near-touchscreen in other embodiments. For instance, a user could press-and-hold, tap, etc. a touchscreen at the location at which the entity representation 425 was displayed in order to provide similar input in some embodiments.

The third and fourth stages 415 and 420 illustrate the entity relationship visualization of some embodiments in which the entity representations are static. The third stage 415 illustrates that the application highlights the representation 425 for the selected entity, displays connections between this selected representation 425 and other non-selected entity representations, and displays various counts of the number of images in which both the selected entity and the various non-selected entities appear. For each non-selected entity that is tagged in an image along with the selected entity, the application draws a line through the GUI. Some embodiments draw these lines so that two lines do not cross. In this case, the lines emanate from either the top or the bottom of the selected entity representation, but may be distributed differently in different embodiments. For a line to a non-selected representation that crosses through other entity representations between the selected representation and the non-selected representation, some embodiments draw the line underneath the intervening representation. For example, the line between the selected representation 425 and the non-selected representation 430 is drawn underneath the non-selected representation 435. In addition, each of the lines to one of the representations for a non-selected entity ends at a GUI item that displays a number. This is the number of images in which both the selected entity and the non-selected entity are tagged. Thus, the number nine for the line connecting to the non-selected entity representation 440 indicates that the image organization application has nine images tagged with both the selected entity and the non-selected entity represented by the representation 440.

In the fourth stage 420, the lines fade away leaving only the highlight of the selected entity and the GUI items indicating the number of images in which the various non-selected entities appear with the selected entity. In some embodiments, the application animates the visualization. Upon selection of the entity representation, the application draws lines emanating from the selected representation to the non-selected representations, then fades these lines out, leaving only the GUI items indicating the co-appearance counts. Other embodiments use different animations, or leave the connection lines in the GUI rather than fading the lines out.

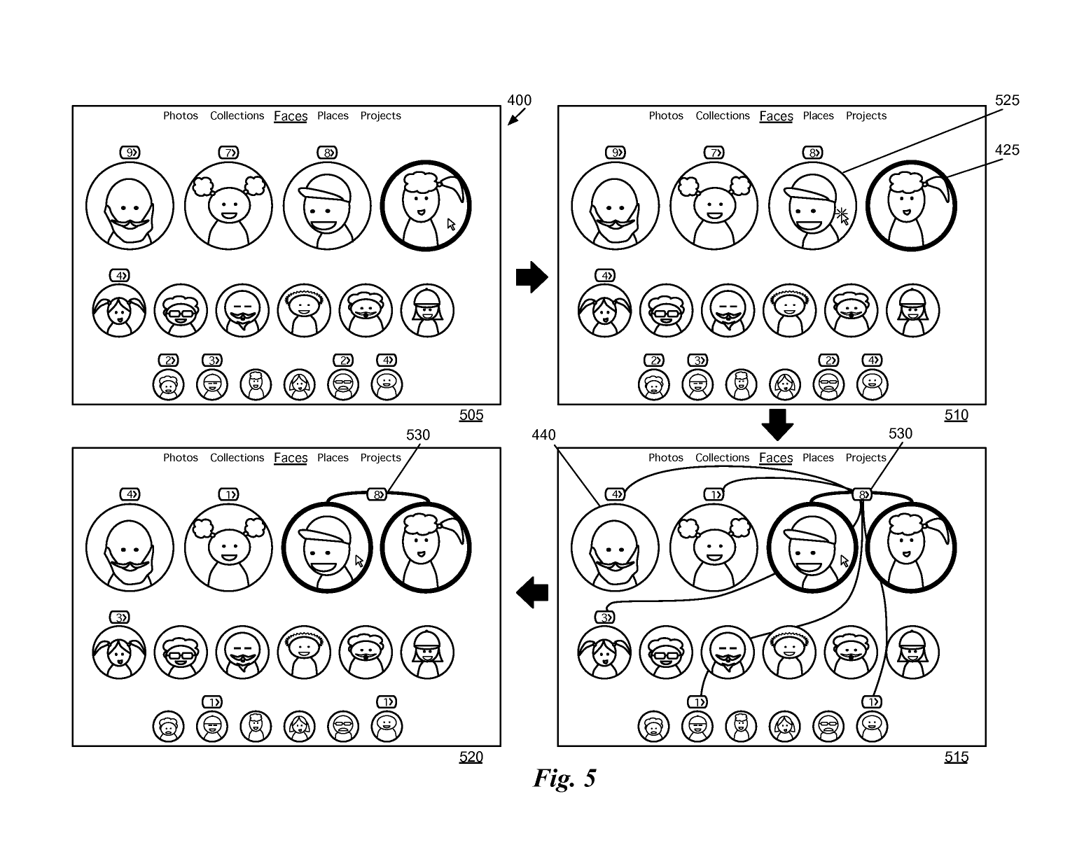

FIG. 5 illustrates the same GUI 400 over four subsequent stages 505-520 as the user selects a second entity representation. The first stage 505 is the same as the final stage 420 of the previous figure. In the second stage 510, the user selects a second representation 525, such that two entities are now selected. The third and fourth stages 515 and 520 illustrate the resulting visualization of some embodiments in the GUI 400.

The third stage 515 illustrates that both of the representations 425 and 525 of the selected entities are now highlighted, and a line is drawn connecting these two representations. In the middle of this line is a GUI item 530 with a number (8) that indicates the count of images that include both of the selected entities. In addition, the application displays connections between this GUI item 530 and the other entities that appear in images including both of the selected entities. For example, the entity shown in representation 440, which appeared in nine images with the first selected entity, appears in four images that include both of the two selected entities. In some embodiments, as shown, the line connecting the selected entities is differentiated from the other connection lines (e.g., by drawing the line thicker, darker, a different color, etc.).

The fourth stage 520 illustrates that the lines to the non-selected entities again have been removed (e.g., faded out), leaving the GUI items that indicate the co-appearance count for the various non-selected entities. Furthermore, the connection between the representations of the two selected entities remains along with the GUI item 530, in order for the user to easily discern which entities are selected and the number of co-appearances of those selected entities.

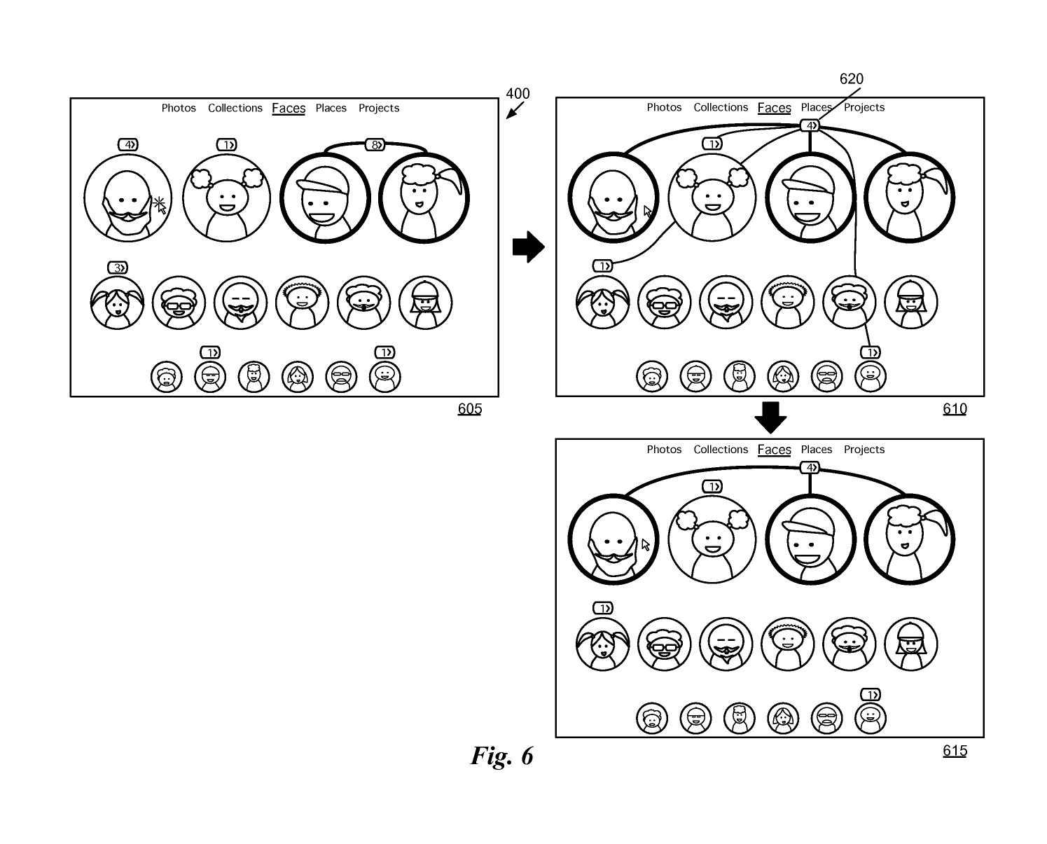

FIG. 6 illustrates the selection of a third entity in the GUI 400 and the resulting visualization over three stages 605-615. In the first stage 605, the GUI 400 is in the same state as at the last stage 520 of the previous figure, and the user selects the representation 440 for another of the entities. The second and third stages 610 and 615 illustrate the display of the relationship visualization now that three of the entities are selected. As in the previous figure, the application highlights the representations of the selected entities and draws a set of lines connecting the selected representations, meeting at a GUI item 620. Just as the GUI item described in the previous figure indicated four images including the two selected entities and one non-selected entity corresponding to entity representations 425, 525, and 440, the GUI item 620 indicates our images now that these three entities are selected. These four images also include one tag each for three additional entities corresponding to the representations 625-635, resulting in three lines emanating from the GUI item 620. The third stage 615 indicates that, again, the lines to the non-selected entities disappear (e.g., are faded out) after a short time period, leaving only the GUI items indicating the counts of co-appearances for the various non-selected entities, and the indications as to the selected entities and their representations.

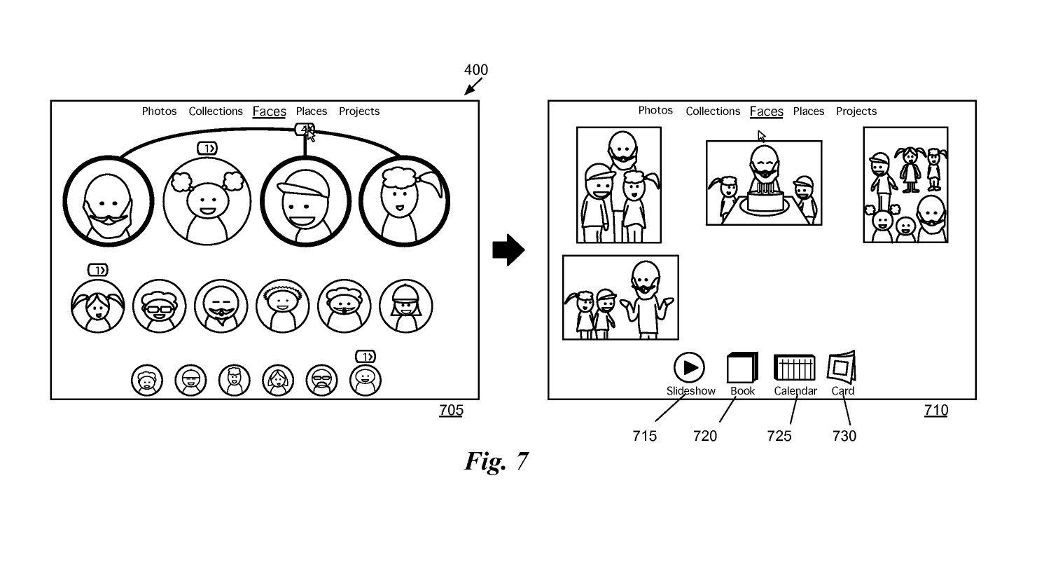

In some embodiments, the GUI items that indicate the number of co-appearances in the image library for a set of entities are selectable to cause the application to display the set of images in which all of the entities in the group appear. FIG. 7 illustrates the selection of the GUI item 620 and the resulting display of images over two stages 705-710 of the GUI 400. As shown, in the first stage 705, the user selects the GUI item 620.

The second stage illustrates that the GUI 400 no longer displays the entity representations, and instead displays a set of four images. Each of these images includes at least the three entities corresponding to the entity representations 425, 525, and 440. In addition, each of the non-selected entities connected to the GUI item 620 in stage 610 of FIG. 6 appear once (in this case, all in the same image). In some embodiments, the application displays thumbnails of the images that fit the selected criteria, and the user can then select any of these thumbnails to view a larger version of the image. In addition, the GUI displays four selectable items 715-730. These four selectable items enable the user to generate new content using the images displayed in the GUI (i.e., images in which the three selected entities all appear). Specifically, users can generate a slideshow, a photobook, a calendar, or a card (e.g., a holiday card) using the selectable items 715-730. In this way, the entity relationship visualization allows a user to easily generate content from images having selected sets of people or other entities in them.

Whereas FIGS. 4-7 illustrate embodiments in which the image organization application keeps the entity representations static, FIGS. 8-10 illustrate embodiments in which the application moves the entity representations within the GUI. Specifically, FIG. 8 illustrates four stages 805-820 of an image organization application GUI 800 in which the user selects representations of several entities and the application displays a visualization of the relationships of the selected entity or entities to each other and to non-selected entities. As shown, the first stage 800 illustrates the GUI 800 before any selections have been made, and is similar to the GUI 200 described above, with various entity representations displayed in three levels of hierarchy. At this stage, the user selects an entity representation 825.

The second stage 810 illustrates the resulting visualization of the relationships between the selected entity corresponding to representation 825 and various non-selected entities. In this case, the application highlights the selected entity by moving the corresponding entity representation 825 to a prominent location in the GUI 800 (in this case, the top center of the display). In addition, the other entity representations are arranged in a hub-and-spoke arrangement, with representations for each of the entities that appear in at least one image along with the selected entity connected to the representation 825 for the selected entity. Along the lines from the selected entity to each of the non-selected entities the application displays a GUI item indicating the number of images in which both the selected entity and the non-selected entity appear. Some embodiments animate this transition from the first stage 805 to the second stage 810 by, e.g., first rearranging the entity representations and then drawing the lines from the selected entity representation to the various non-selected entities.

To determine the arrangement of the various representations in the second stage 810, different embodiments use different techniques. Some embodiments arrange the representations based on the different hierarchical groups, with the largest representations on one side (e.g., the left), then the representations decreasing in size from that side to the other. Other embodiments arrange the representations in order from the largest number of co-appearances to the fewest, while still other embodiments calculate the locations that will result in the smallest total movement of the entity representations. Some embodiments also arrange the representations for the non-selected entities with no co-appearances in the same way (e.g., from largest to smallest representation, or based on smallest overall movement distance).

In the third stage 815, the user selects the representation 830 for one of the entities that appears in at least one image along with the previously selected entity. The fourth stage 820 illustrates the resulting visualization of the relationships between the two selected entities and various non-selected entities. In this case, the representations 825 and 830 of the two selected entities are moved into the prominent location in the GUI, and a line 840 is drawn connecting them. In the middle of this line is a GUI item 835 indicating the number of images in which both of the selected entities appear (8). In addition, fanning out of the line 840 are additional lines for each of the non-selected entities that appear in at least one of the eight images with the two selected entities. As with the previous transition, some embodiments animate the transition between the stages 815 and 820. In some embodiments, the application removes the lines indicating connections, rearranges the entity representations, and then redraws the lines to the newly arranged entities.

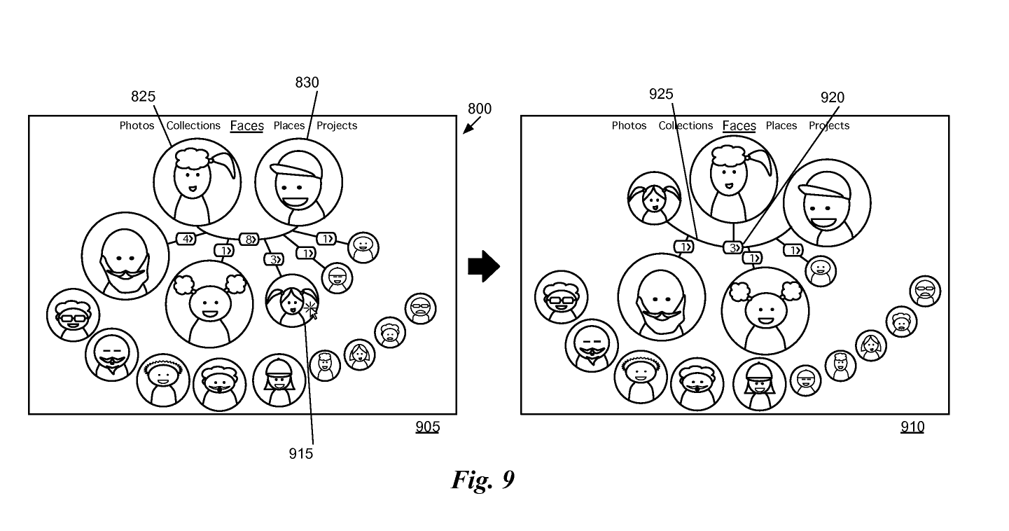

FIG. 9 illustrates two stages 905-910 of the GUI 800 in which the user selects a third entity for the relationship visualization. The first stage 905 illustrates the GUI 800 in the same state as the last stage 820 of the previous figure, with the two entities corresponding to the entity representations 825 and 830 already selected. In this stage, the user selects a third entity representation 915. As a result, the second stage 910 displays the three selected entity representations 825, 830, and 915 at the top of the GUI, with a line 925 connecting them and a GUI item 920 along this line, and with the representations for three non-selected entities connected to a line between these three. As shown in this figure, the user may select entities from different hierarchical groups.

In all of the above examples, the second and third selections of are entities that are tagged in at least one image along with the previously-selected entities. In some embodiments, if a user selects one of the representations for an entity with no co-appearances, the image organization application nullifies the previous selections such that the newly selected entity is the only selected entity. Other embodiments, however, prevent the user from selecting entities that do not have any images in common with the currently selected entities.

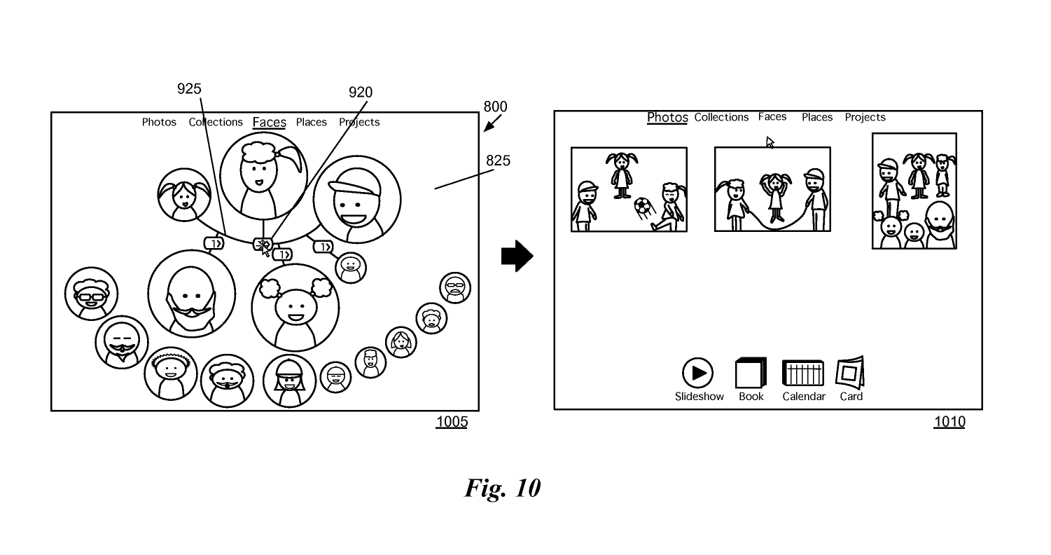

FIG. 10 illustrates the selection of a GUI item 920 and the resulting display of images over two stages 1005-1010 of the GUI 800. As shown, in the first stage 705, the user selects the GUI item 920. The second stage illustrates that the GUI 800 no longer displays the entity representations, and instead displays a set of four images. As in the previous example of FIG. 7, each of these images includes at least the three entities corresponding to the entity representations 825, 830, and 915. In addition, each of the non-selected entities connected to the line 925 appear once (in this case, all in the same image). As in FIG. 7, the GUI displays four selectable items that allow the user to generate new content using the images displayed in the GUI.

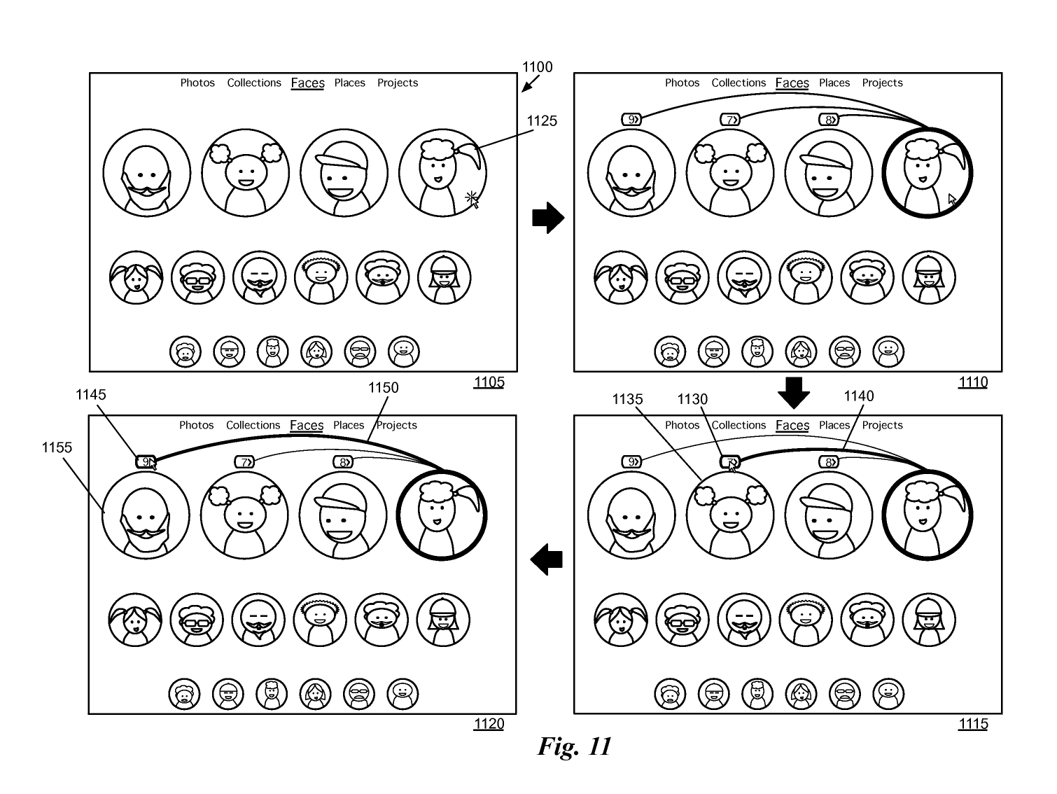

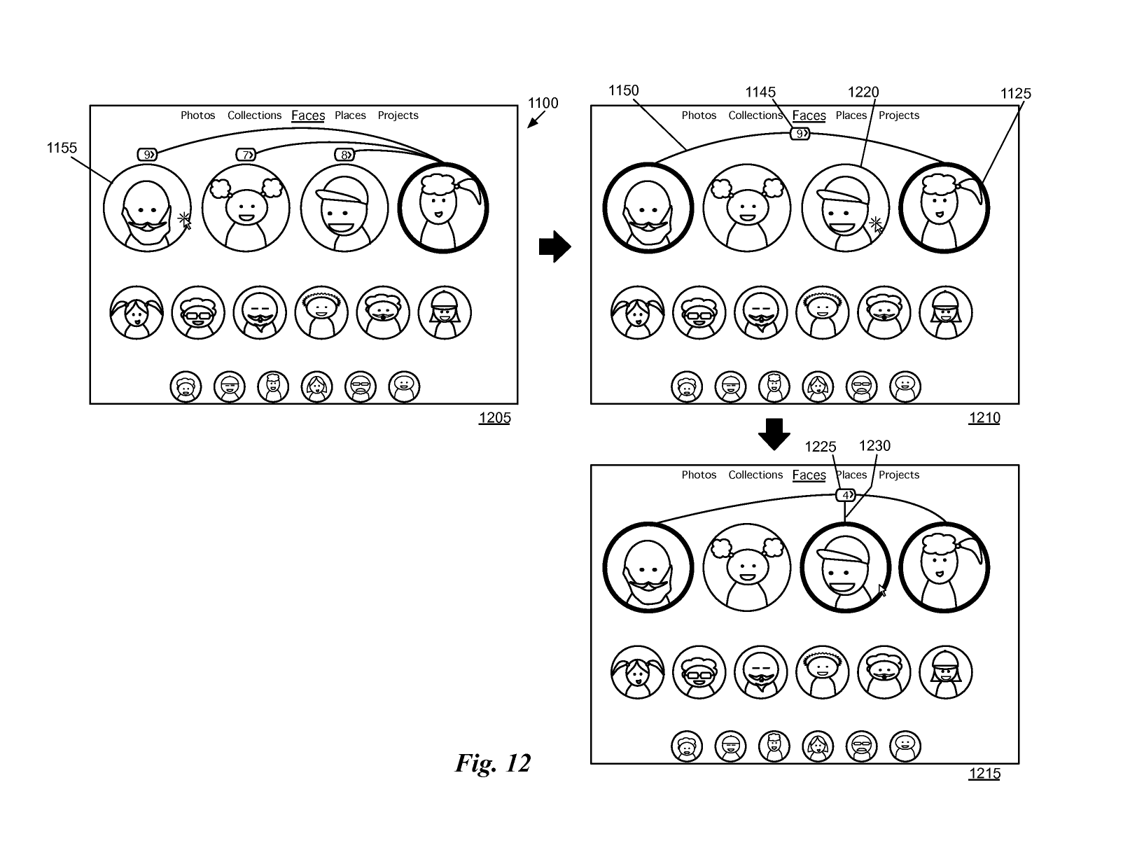

FIGS. 11 and 12 illustrate a third visualization of relationships between entities that appear in images of an image organization application of some embodiments. In these embodiments, the entity representations are static in the GUI, but the application does not fade the lines out of the display after a period of time. However, once more than one entity has been selected, the application only displays the connections between selected entities, and does not display information regarding the number of co-appearances of various non-selected entities with the selected entities.

FIG. 11 illustrates an image organization application GUI 1100 over four stages 1105-1120 in which the user selects a representation of an entity in order to cause the application to display a visualization of the relationships of the selected entity to other entities that appear in the user's library of images. As shown, the first stage 1105 illustrates the GUI 1100 before any selections have been made. This stage 1105 is similar to the GUI 200 described above. In addition, at this stage the user selects an entity representation 1125.

The second stage 1110 illustrates the resulting visualization. As shown, the application draws lines from the representation 1125 of the single selected entity to the representations of several non-selected entities. As in this case, in some embodiments, the application limits the non-selected entities to which connections are shown to those entities in the same hierarchical group as the selected entity (in this example, the top group with the largest entity representations). This visualization is similar to that shown in the first set of FIGS. 4-7; however, the connecting lines do not fade away after a period of time as in the embodiments shown in those previous figures.

The third and fourth stages 1115 and 1120 illustrate an additional aspect of the visualizations of some embodiments. In the third stage, the user moves the location indicator over a GUI item 1130 that indicates the number of images in which the selected entity and the particular non-selected entity corresponding to the representation 1135 both appear. While selecting this GUI item would cause the application to present these seven images in the GUI, moving the location indicator over the item causes the application to highlight the connection 1140 between the entity representation 1125 for the selected entity and the entity representation 1135 for the particular non-selected entity. Similarly, in the fourth stage, the user moves the location indicator over a GUI item 1145 for a different non-selected entity, and the connection 1150 between that different entity's representation 1155 and the selected entity representation 1125 is highlighted.

FIG. 12 illustrates three stages 1205-1215 of the GUI 1100 in which the user selects additional entities. The first stage 1205 illustrates the GUI 1100 in the same state as the stage 1120 of the previous figure. In addition, at this stage, the user selects the entity representation 1155. As shown in the second stage 1210, the application now highlights both of the selected entity representations 1125 and 1155, and moves the GUI item 1145 to the center of the connection 1150 between the two entities. In addition, in these embodiments, the application does not draw additional connections to non-selected entities that appear in images along with the two selected entities. Instead, once at least two entities have been selected, the application indicates only the connection between the selected entities. While this provides less information than the previously-illustrated embodiments, the visualization is simpler and allows the user to see the desired information for the selected entities.

Also in the second stage, the user selects a third entity representation 1220. The third stage 1215 illustrates that, as a result, the application draws a connection to a new GUI item 1225 that indicates the number of images in which all three of the selected entities appear. Some embodiments animate the transition between the second stage 1210 and the third stage 1215 by moving the GUI item along the connection 1150 while changing the number displayed by the GUI item, while also drawing the connection 1230. While not shown in FIGS. 11 and 12, the GUI items (e.g., GUI items 1145 and 1225) are selectable to cause the application to display the images in which the corresponding entities appear in some embodiments, as shown in FIGS. 7 and 10.

One of ordinary skill in the art will recognize that different embodiments that use various combinations of the above-described features may also be possible for visualizing the relationships of entities within a set of content items, whether those content items are images in a photo library of an image organization application, or other types of content. For instance, the application could rearrange the entities as shown in FIGS. 8-10, and also have the connections highlightable by moving a location indicator over the corresponding GUI items as in FIG. 11. In addition, though not shown in these figures, in some embodiments the user can provide selection input over an already-selected entity representation in order to deselect that entity, in which case the application provides the visualization for only the still-selected entities (e.g., a transition from stage 820 to stage 815 of FIG. 8.

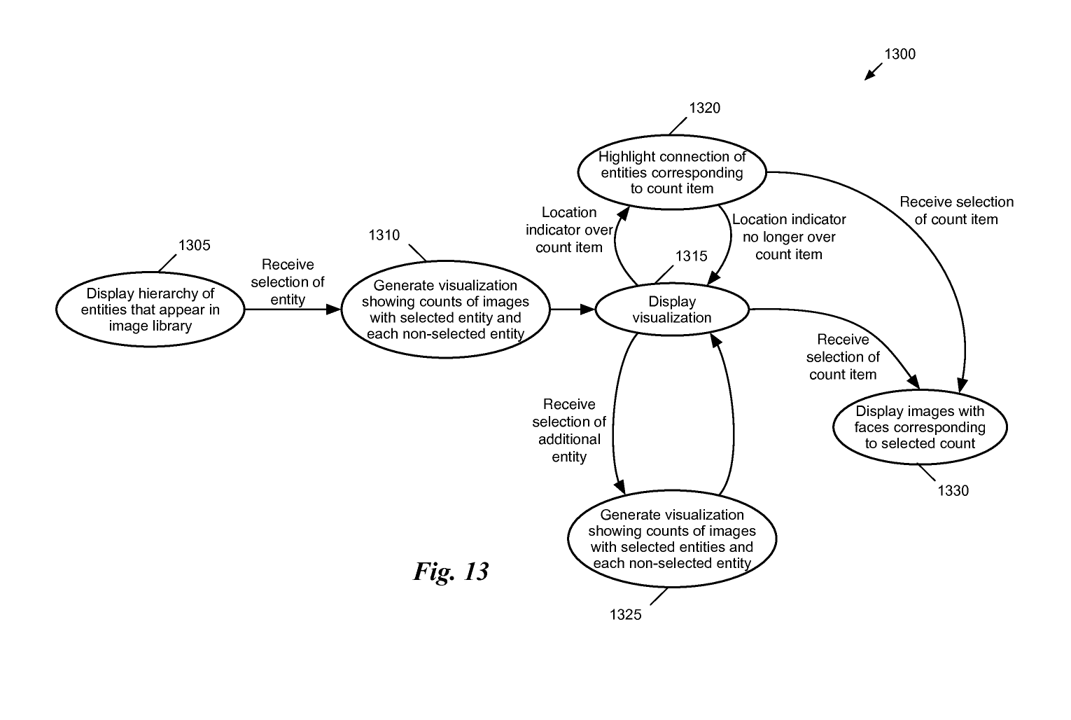

FIG. 13 conceptually illustrates a state diagram 1300 that shows states and changes between the states for the image organization application GUI of some embodiments. One of ordinary skill in the art will recognize that this state diagram does not cover every possible interaction with the image organization application. For instance, the state diagram does not describe changing the selected tabs (i.e., items 205-209 of the GUI 200 in FIG. 2), or selecting a single entity representation to view the images in which that single entity appears. Instead, the state diagram 1300 is restricted to interactions relating to the visualization of relationships between the entities. In addition, some embodiments may only perform a subset of the operations shown or may perform variations of the operations shown in the state diagram. In each of the states shown in the state diagram 1300, the operations of the image organization application are controlled by one or more application processes that are responsible for handling the user interaction with the image organization application GUI.

When a user has not interacted with the image organization application except to select a GUI item that causes a display of the entity representations (e.g., faces tab 207 of FIG. 2), the GUI is in state 1305, at which the image organization application displays a hierarchy of entities that appear in the image library of the application. For example, the GUI 200 shown in FIG. 2 illustrates this state, with no entities yet selected.

Once a user selects a first entity, however, the application GUI transitions to the state 1310 to generate a visualization showing the counts of images with the selected entity and each non-selected entity (or at least each of a set of the non-selected entities). The application, in some embodiments, performs the operations 310-330 of FIG. 3 or similar operations at this state, in order to generate the visualization. The application then transitions to state 1315 to display the generated visualization. This visualization of the relationships between the selected entity and the non-selected entities may be any of the various types of visualizations shown in the previous examples, or a different visualization. For instance, stages 415 and 420 of FIG. 4, 810 of FIG. 8, or 1110 of FIG. 11 illustrate examples of the graphically displayed relationships between entities with one entity selected.

While in this state, the user can provide various inputs to further affect the GUI. In some embodiments, if the user moves a location indicator over a particular count item such as the GUI items 1130 or 1145 (or provides a different input in other embodiments), the application transitions to state 1320 to highlight the connection between the entities (or the entity representations) corresponding to the particular count item. Examples of this operation are shown in stages 1115 and 1120 of FIG. 11. In addition, for the visualization shown in the GUI 400 of FIGS. 4-7, when a user moves the location indicator over a GUI item in some embodiments, the application redraws the transient connection to which the GUI item corresponds. For the visualization shown in the GUI 800 of FIGS. 8-10, some embodiments highlight a connection between the selected entity representations and a non-selected representation when the user moves a location indicator over the corresponding GUI item.

In addition, while the application is in the state 1315, the user may select an additional entity representation within the GUI, causing the application to transition to state 1325. At this state 1325, the application generates a new visualization that shows the counts of images with the selected entities and each non-selected entity (or at least each of a set of the non-selected entities), then transitions back to state 1315 to display the generated visualization. The application, in some embodiments, again performs the operations 310-330 of FIG. 3 or similar operations in order to generate the visualization. This visualization of the relationships between the selected entities and the non-selected entities may be either of the visualizations shown in FIGS. 5 and 3 or 8 and 9, or a different visualization. Some embodiments, such as those shown in FIG. 12, do not display relationships to the non-selected entities once at least two entities are selected. In this case, the generated visualization only displays the relationship between the selected entities.

In addition, from either state 1315 or 1320, the user can select one of the count items in order to cause the application to transition to state 1330. In state 1330, the application displays the images that contain the entities corresponding to the selected count item (i.e., images in which the entities are all tagged). Examples of this state of the GUI include stage 710 of FIG. 7 and stage 1010 of FIG. 10.

### III. Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

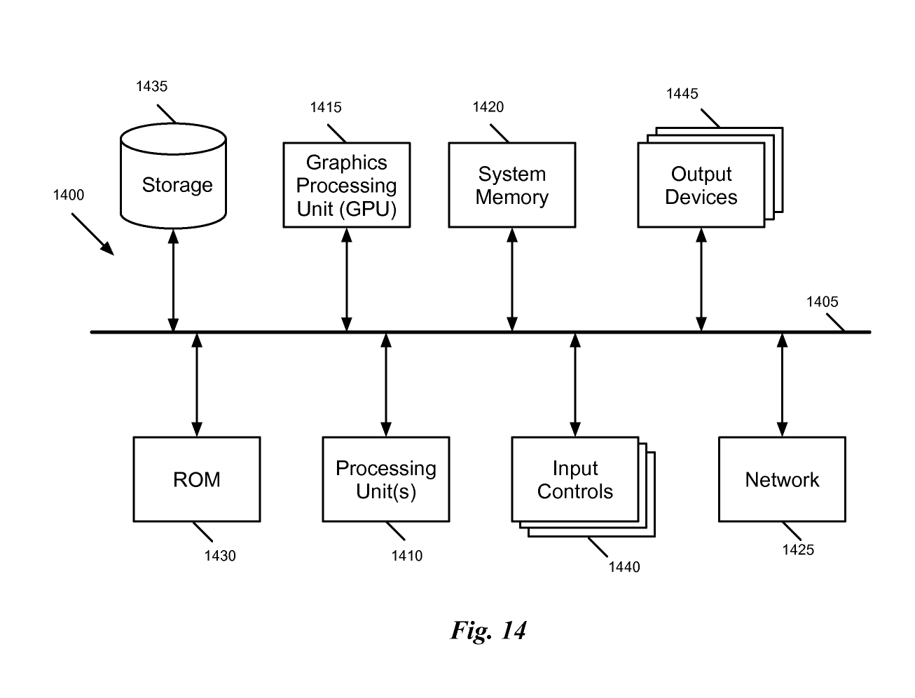

FIG. 14 conceptually illustrates another example of an electronic system 1400 with which some embodiments of the invention are implemented. The electronic system 1400 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1400 includes a bus 1405, processing unit(s) 1410, a graphics processing unit (GPU) 1415, a system memory 1420, a network 1425, a read-only memory 1430, a permanent storage device 1435, input devices 1440, and output devices 1445.

The bus 1405 collectively represents all system, peripheral, and chipset buses that communicatively connect the numerous internal devices of the electronic system 1400. For instance, the bus 1405 communicatively connects the processing unit(s) 1410 with the read-only memory 1430, the GPU 1415, the system memory 1420, and the permanent storage device 1435.

From these various memory units, the processing unit(s) 1410 retrieves instructions to execute and data to process in order to execute the processes of the invention. The processing unit(s) may be a single processor or a multi-core processor in different embodiments. Some instructions are passed to and executed by the GPU 1415. The GPU 1415 can offload various computations or complement the image processing provided by the processing unit(s) 1410. In some embodiments, such functionality can be provided using CoreImage's kernel shading language.

The read-only-memory (ROM) 1430 stores static data and instructions that are needed by the processing unit(s) 1410 and other modules of the electronic system. The permanent storage device 1435, on the other hand, is a read-and-write memory device. This device is a non-volatile memory unit that stores instructions and data even when the electronic system 1400 is off. Some embodiments of the invention use a mass-storage device (such as a magnetic or optical disk and its corresponding disk drive, integrated flash memory) as the permanent storage device 1435.

Other embodiments use a removable storage device (such as a floppy disk, flash memory device, etc., and its corresponding drive) as the permanent storage device. Like the permanent storage device 1435, the system memory 1420 is a read-and-write memory device. However, unlike storage device 1435, the system memory 1420 is a volatile read-and-write memory, such a random access memory. The system memory 1420 stores some of the instructions and data that the processor needs at runtime. In some embodiments, the invention's processes are stored in the system memory 1420, the permanent storage device 1435, and/or the read-only memory 1430. For example, the various memory units include instructions for processing multimedia clips in accordance with some embodiments. From these various memory units, the processing unit(s) 1410 retrieves instructions to execute and data to process in order to execute the processes of some embodiments.

The bus 1405 also connects to the input and output devices 1440 and 1445. The input devices 1440 enable the user to communicate information and select commands to the electronic system. The input devices 1440 include alphanumeric keyboards and pointing devices (also called “cursor control devices”), cameras (e.g., webcams), microphones or similar devices for receiving voice commands, etc. The output devices 1445 display images generated by the electronic system or otherwise output data. The output devices 1445 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 14, bus 1405 also couples electronic system 1400 to a network 1425 through a network adapter (not shown). In this manner, the computer can be a part of a network of computers (such as a local area network (“LAN”), a wide area network (“WAN”), or an Intranet), or a network of networks, such as the Internet. Any or all components of electronic system 1400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (including FIG. 3) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for displaying relationships in content, the method comprising:
from a plurality of entities that appear in a set of content items and for which representations are displayed in a graphical user interface (GUI), receiving a selection of one or more of the entities through the representations in the GUI;
for each non-selected entity of a set of non-selected entities of the plurality of entities, determining a count of content items in the set of content items in which the one or more selected entities and the non-selected entity appear; and
displaying in the GUI a visualization of the representations of the plurality of entities that indicates which of the entities are selected and the counts for each of the set of non-selected entities.

2. The method of claim 1 further comprising determining a count of content items in the set of content items in which the one or more selected entities appear, wherein the displayed visualization further indicates the count of content items in which the one or more selected entities appear.

3. The method of claim 1, wherein the content items are photographs and the entities are faces of people that appear in the photographs.

4. The method of claim 1, wherein the set of content items is an image library of an image viewing and organization application.

5. The method of claim 1, wherein the displayed visualization comprises a selectable item for a combination of the selected entities and a particular non-selected entity that indicates the count of content items in the set of content items in which the selected entities and the particular non-selected entity appear.

6. The method of claim 5 further comprising:
receiving a selection of the selectable item; and
displaying the content items in which the selected entities and the particular non-selected entity appear.

7. The method of claim 1, wherein the count of content items for a particular non-selected entity comprises all of the content items in the set in which each of the selected entities and the particular non-selected entity appears, including at least one content item in which a different non-selected entity appears.

8. The method of claim 1, wherein displaying the visualization comprises:
highlighting the representations of the selected entities;
displaying a graphical connection of the representations of the selected entities and a particular non-selected entity; and
along with the graphical connection, displaying the count of images in which the selected entities and the particular non-selected entity appear.

9. The method of claim 8, wherein the graphical connection is transiently displayed, the method further comprising removing the graphical connection to display the count without the graphical connection.

10. The method of claim 8, wherein displaying the visualization further comprises, for each entity of the set of non-selected entities:
displaying a graphical connection of the representation of the selected entities and the non-selected entity; and
along with the graphical connection, displaying the count of images in which the selected entities and the non-selected entity appear.

11. The method of claim 8, wherein displaying the visualization further comprises:
rearranging the entities to display the selected entities next to each other;
displaying a graphical connection between the representations of the selected entities that indicates a count of images in which all of the selected entities appear, wherein the graphical connection of the selected entities and the particular non-selected entity is displayed as a connection off of the connection between the selected entities.

12. A method for displaying relationships between entities that appear in images, the method comprising:
identifying a selection of two or more entities of a plurality of entities that appear in a set of images;
determining a number of images in the set of images in which the two or more selected entities each appear; and
displaying a graphical representation of the plurality of entities that graphically connects the selected entities and the determined number of images in which the two more selected entities each appear.

13. The method of claim 12, wherein the plurality of entities are faces of people that are displayed in a hierarchy, with a first set of the faces displayed as larger than the other faces.

14. The method of claim 13, wherein the hierarchy is based on a count of the number of images in the set of images containing each of the faces, wherein the faces in the first set appear in the most images.

15. The method of claim 13, wherein the hierarchy is based on user selection of the first set of faces.

16. The method of claim 12, wherein displaying the graphical representation comprises:
highlighting the selection of the two or more entities;
displaying lines connecting the selected entities; and
displaying a selectable item indicating the number of images in which the two or more selected entities appear.

17. The method of claim 16 further comprising:
receiving a selection of the selectable item; and
in response to the selection, displaying the images in which the two or more selected entities appear.

18. The method of claim 12 further comprising, for each of a set of non-selected entities, determining a number of images in the set of images in which the two or more selected entities and the non-selected entity each appear, wherein the displayed graphical representation further graphically connects the selected entities to the set of non-selected entities and indicates the determined numbers of images in which the two or more selected entities and each non-selected entity appear.

19. A machine readable medium storing a program which when executed by at least one processing unit displays relationships in content, the program comprising sets of instructions for:
from a plurality of entities that appear in a set of content items and for which representations are displayed in a graphical user interface (GUI), receiving a selection of one or more of the entities through the representations in the GUI;
for each non-selected entity of a set of non-selected entities of the plurality of entities, determining a count of content items in the set of content items in which the one or more selected entities and the non-selected entity appear; and
displaying in the GUI a visualization of the representations of the plurality of entities that indicates which of the entities are selected and the counts for each of the set of non-selected entities.

20. The machine readable medium of claim 19, wherein the program further comprises a set of instructions for determining a count of content items in the set of content items in which the one or more selected entities appear, wherein the displayed visualization further indicates the count of content items in which the one or more selected entities appear.

21. The machine readable medium of claim 19, wherein the displayed visualization comprises a selectable item for a combination of the selected entities and a particular non-selected entity that indicates the count of content items in the set of content items in which the selected entities and the particular non-selected entity appear.

22. The machine readable medium of claim 19, wherein the count of content items for a particular non-selected entity comprises all of the content items in the set in which each of the selected entities and the particular non-selected entity appears, including at least one content item in which a different non-selected entity appears.

23. The machine readable medium of claim 19, wherein the set of instructions for displaying the visualization comprises sets of instructions for:
highlighting the representations of the selected entities;
displaying a graphical connection of the representations of the selected entities and a particular non-selected entity; and
along with the graphical connection, displaying the count of images in which the selected entities and the particular non-selected entity appear.
